(19) United States
(12) Patent Application Publication
(10) Pub. No.: US 2004/0125405 A1
(43) Pub. Date: Jul. 1, 2004

(54) Automatically determining labeling requirements

(76) Inventors: Thomas Salomon, Rauenberg (DE); Ingo Sigmund, Wilmington (DE); Ralph Merkle, Mlmenhausen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/335,135

(22) Filed: Dec. 30, 2002

(51) Int. Cl. G06F 15/00

(52) U.S. Cl. 358/1.18; 358/1.12

(57) ABSTRACT

Methods and apparatus, including computer-program products, for automatically determining labeling requirements. A computer-implemented method for determining label requirements includes receiving a request that includes information describing one of one or more products, one or more materials, and packaging. The method includes identifying, based on the request, one or more packaging layers that are to be labeled. The method includes selecting, for each packaging layer identified, one or more label templates. The method includes determining data that is needed to complete the label templates selected. The method includes retrieving the data from memory. The method includes generating a representation of the packaging label using the one or more label templates and the data.

### BACKGROUND

The present invention relates to labeling products and materials.

Generally, labels are required for different purposes in an enterprise. For example, labels can be used to identify products or materials. Labels can also be used to communicate other information such as, for example, manufacturer contact information, quantity, expiration date, directions for use, and safety precautions.

Labels can also be required by regulations. A jurisdiction can, for example, require warning labels for hazardous materials. Sometimes, labeling requirements are dictated by different regulations. For example, when a product is shipped through more than one jurisdiction and is, hence, subject to different regulations, labels need to comply with the different regulations. Regulations can dictate not only the content of a label, but also the shape, size, color, and design of a label.

In general, labeling requirements can depend on the needs of an enterprise, different regulations, the product or material to be labeled, properties of the product or material, the packaging of the product or materials, and the process associated with the product or material.

Labels are usually affixed to the packaging of products or materials. Packaging can include many layers. Soda pop, for example, can be packaged in a can. Six cans can be packaged in a six-pack. Four six-packs, in turn, can be packaged in a box. The packaging that holds the smallest unit of the product or material is the primary packaging. In the example given, the can is the primary packaging. The various packaging of a product or material makes a packaging hierarchy. The packaging hierarchy can generally be represented as a packaging tree. Each layer of packaging, i.e., the can, the six-pack, and the box, can be represented by a level in the packaging tree. In the example given, there are three packaging layers, the primary packaging layer, a middle packaging layer, and an outer packaging layer. The outer packaging layer includes the middle and primary packaging layers. Generally, a packaging hierarchy can have any number of packaging layers and any of the packaging layers can be labeled.

### SUMMARY

The present invention provides methods and apparatus, including computer program products, for automatically determining labeling requirements.

In general, in one aspect, a computer-implemented method for determining label requirements includes receiving a request that includes information describing one of one or more products, one or more materials, and packaging. The method includes identifying, based on the request, one or more packaging layers that are to be labeled. The method includes selecting, for each packaging layer identified, one or more label templates. The method includes determining data that is needed to complete the label templates selected. The method includes retrieving the data from memory. The method includes generating a representation of the packaging label using the one or more label templates and the data.

In general, in another aspect, a computer program product for determining labeling requirements is operable to cause a data processing apparatus to receive a request that includes information describing one of one or more products and materials, the information also describing packaging. The product is operable to cause the data processing apparatus to identify, based on the request, one or more packaging layers that are to be labeled. The product is operable to cause the data processing apparatus to select, for each packaging layer identified, one or more label templates. The product is operable to cause the data processing apparatus to determine data that is needed to complete the label templates selected. The product is operable to cause the data processing apparatus to retrieve the data from memory. The product is operable to cause the data processing apparatus to generate a representation of the packaging label using the one or more label templates and the data. The is tangibly embodied in an information carrier.

The invention can be implemented to realize one or more of the following advantages. A system as described in this specification can determine automatically labeling requirements for each packaged product or material. The system can select the appropriate labels for each packaging layer. The system can calculate how many labels must be applied to each packaged product or material. The system can retrieve from a memory information needed to complete and generate the labels. The system reduces the time spent determining how many of a particular label is needed for each unit of packaging. The system can automatically determine the appropriate label for use in a geographic region. Automatic determination of labels simplifies the supply chain and improves collaboration between partners in the supply chain. Automatic label determination provides uniform products to customers and reliable label data. The process allows for standardization in labeling. The user can design labels once and use them consistently worldwide. By automating the generation of labels, the probability of operator error is reduced. The operators of the system need not to have more than a limited knowledge of particular applications or systems associated with labeling. The system can match required symbols and data item to be printed on labels according to certain variables and, therefore, eliminates the burden of individually determining the necessary label symbols and data items. This feature increases the efficiency of the labeling process. Other advantages allow for maintenance of data as separate objects, data structures, and tables. The system then uses the objects, tables, and data structures to determine information to be printed on the labels.

The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

FIG. 1 shows a method for automatically determining labeling requirements.

FIG. 2 shows an implementation of the method for automatically determining labeling requirements.

FIG. 3 shows an example of a labeling tree.

FIG. 4 shows an example graphical user interface for generating labels.

FIG. 5 shows a method for maintaining label data in a material master.

FIG. 6 shows an example user interface for maintaining label data in a material master.

FIG. 7 shows examples of components of a labeling specification.

FIG. 8 shows a detailed method for determining label requirements.

Like reference numbers and designations in the various drawings indicate like elements.

### DETAILED DESCRIPTION

At least two factors affect the method of label creation. The first factor is business interests of the entities that deal with the packaged materials. Those entities, for example, may need to be able to accurately identify the contents of a package and have access to other material related information. One of the problems related to labeling is the time and knowledge required to accurately label products or materials. Typically, one label is not suitable for all labeling situations. Therefore, labels must be customized for each product that is packaged and then matched with the packaged products. The second factor is the regulatory requirements for labeling. In many industries, there are regulatory agencies that set the requirements for labeling, such as the United States Food and Drug Administration. The same food item can be packaged for distribution in multiple countries. In the United States, food labels require at least a minimum amount of information regarding ingredients and nutritional value. Regulatory agencies in other countries do not require the same level of content to be printed on labels and/or need the information to be written in the local language. A food labeler must adhere to the applicable standards to comply with local regulations and market requirements. Business and regulatory concerns, as well as other concerns, can be addressed by an automatic label determination system.

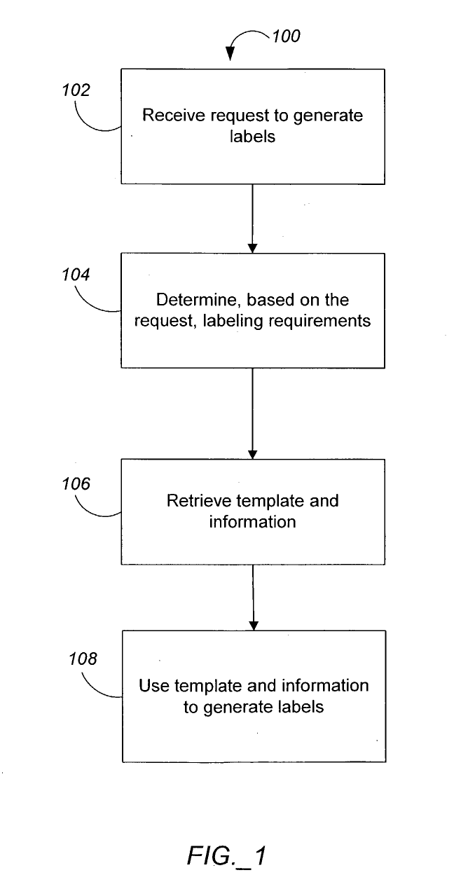

FIG. 1 shows a method 100 for automatically determining labeling requirements. The system receives a request to generate one or more labels (step 102). The request can specify the product or material to be labeled, the packaging layer to be labeled, and the operation associated with the packaged product or material. The specification of the operation can include a specification of one or more countries through which the products or materials will be shipped and, furthermore, the mode of shipment. The request can also specify other information such as, for example, whether labels are needed for packaging layers, if any, included in the packaging layer specified, customer information, and regulations that dictate labeling requirements. The request can come from a human operator of the system or from a computer program.

The system determines, based on the request, the labeling requirements (step 104). Determining labeling requirements can include, when the packaging layer specified in the request includes other packaging layers, determining which packaging layers need labels. Determining labeling requirements can also include selecting, for each packaging layer that needs to be labeled, one or more appropriate label templates. The label templates can be predefined and, furthermore, can specify the information needed to generate the labels. The system uses the information specified in the request to select label templates. If, for example, there is an order to ship a particular amount of sodium chloride, NaCl, from Germany to Italy, the system selects the particular label templates associated with shipping NaCl from Germany to Italy. The system can then use the selected templates to identify the information needed to complete the templates. The templates and information needed to complete the templates can be stored in one or more data structures. In one implementation, the information is stored in material master records. The system retrieves the templates and information (step 106). The system uses the templates and retrieved information to generate labels (step 108).

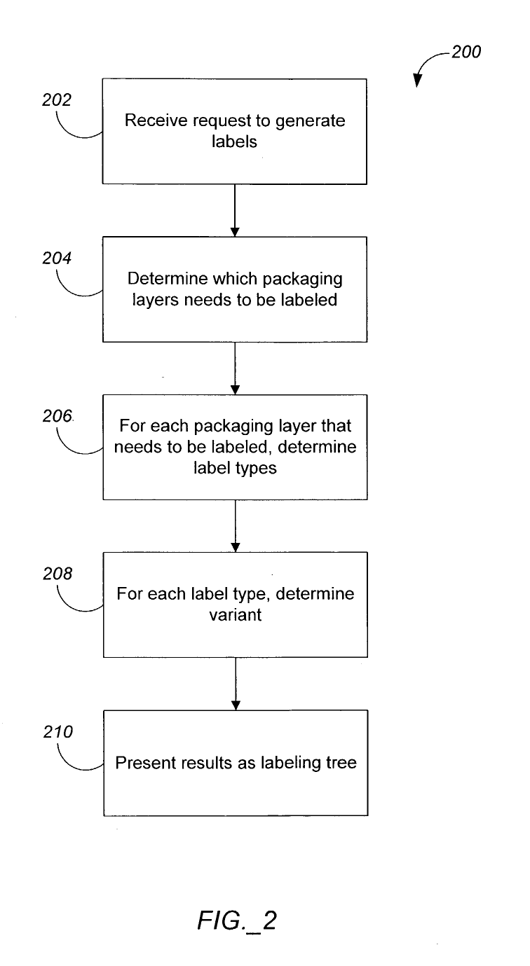

FIG. 2 shows one implementation 200 for automatically determining labeling requirements. The system receives a request to generate labels (step 202). The request includes information that specifies the product or material to be labeled, a packaging layer, whether a packaging hierarchy is to be exploded when the request specifies a packaging layer that includes other packaging layers, the number of items that have to be labeled, a customer number, one or more shipping modes, and one or more validity areas. The customer number identifies a customer and can be used to retrieve label types that have been defined for or by the customer. Label types are a species of label templates, and can describe a label according to the label's purpose. Examples of label types can include primary, overpack, transportation, shipment, sample, internal, customer, and waste. Any type of label can be created or chosen for packaging. Shipping modes can include road, air, rail, sea, and other available options. The validity areas represent geographical regions, which have labeling regulations and are further described below.

The system determines which of the packaging layers needs to be labeled (step 204). The determination includes checking whether the-request specifies more than one packaging layer. That is, the system can check if the packaging layer specified in the request includes other packaging layers. If there is only one packaging layer, then this packaging layer is the only packaging layer that needs to be labeled. If there is more than one packaging layer specified in the request, the system checks for an indication, which can be a flag, that indicates that the packaging layers included in the one specified in the request also need labels. In this latter case, the label determination process can include a process that explodes the packaging hierarchy. Packaging hierarchy explosion is further described below.

For each packaging layer that needs to be labeled, the system determines which label types are needed (step 206). The system uses the information in the request and information stored in memory that describes labeling requirements to determine label types for the current packaging layer. Multiple label types can be required for each packaging layer and therefore multiple types of labels can be generated and applied to each layer.

For each label type, the system determines a variant (step 208). Variants are species of label types that are either specific to a customer, a material or product, a packaging layer, a shipping mode and country, or any combination of a customer, a material or product, a packaging layer, and a shipping mode and country.

Determining variants includes checking whether there are customer specific variants for the current label type. If there are, then the system selects the variant as the label for the current packaging layer. Otherwise, the system determines a variant by defining the variant as described below.

Determining variants also includes checking whether there is a product or material specific label type, i.e., a product or material variant, for the current packaging layer. If there is, then the system selects the product or material variant for the current packaging layer.

Variants can also be specified for the shipping mode and country through which the packaged products or materials are sent. Each shipping mode and country can require different forms of labels. These variants can be associated and stored with each of the shipping modes and countries and the system can retrieve the variant as needed. Otherwise, the system defines a variant as follows.

To define a variant, the system refers to the labeling specification and checks if there is a variant associated with the current packaging layer. If there is, then the system selects this variant for the current packaging layer. If there is not, then the system refers to the labeling specification and determines a label size for the current label type. The system checks whether there are use symbols associated with the current label type. Use symbols indicate the proper handling of the product or material. If there are use symbols associated with the current label type, then the system selects the appropriate use symbols. The selection is based on information in the request. The system checks whether there are transport symbols associated with the current label type. If there are transport symbols associated with the current label type, then the system selects the appropriate transport symbols. The selection is based on information in the request. The system uses the current label type, determined label size, determined number of use symbols, and determined number of transport symbols to determine a label stock. The system then determines the label variant using the current label type, determined label stock, validity areas, and shipping mode. The system can identify all variants that are needed to produce labels for all validity areas specified in the request. Generally, it is not sufficient to search for a variant that is associated with a superset of the validity regions.

The system determines if there are released reports associated with the determined variant and uses the reports to generate a labeling tree, which is further described below. If there is no released report associated with the variant, then the variant itself is used. The released report is a data sheet that is needed for the different environments in which the labels are used. Examples of reports include material safety data sheets and transport emergency cards. Material safety data sheets are used to relay information regarding chemical goods handling. Transport emergency cards, or tremcards are carried by handlers of dangerous goods and contain information that enables the correct measures to be taken in the event of an accident. Special regulations regarding the content and layout of the tremcards apply for each mode of transport and therefore a report must comply with applicable regulations at which time the report can be released.

The system presents the results as a labeling tree (step 210). The system uses the determined variants to generate labels and presents the results as a labeling tree that includes all labels for a specific labeling case. The tree separates the various labels that are needed into separate levels. The system identifies all packaging layers on the topmost level. At the next level, the system identifies all label types for each packaging layer. Below the label type level, the system identifies variants or specific labels that have been found for each packaging layer and label type.

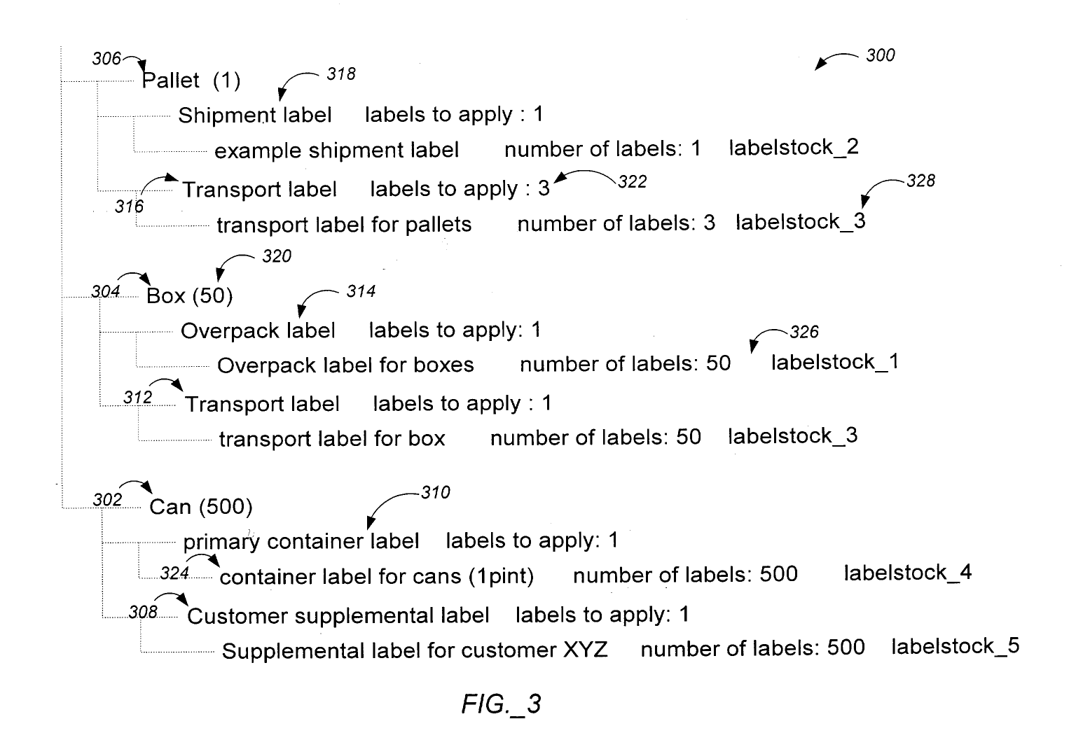

FIG. 3 shows an example of a labeling tree 300. The labeling tree shows three packaging layers, a layer of cans 302, a layer of boxes 304, and a layer of pallets 306. The labeling tree indicates that there are six label types: the customer supplemental label 308, primary container label 310, transport label 312, overpack label 314, transport label 316, and shipment label 318.

The labeling tree can also show other information. For example, the labeling tree can include an indicator, such as, e.g., indication 320, that shows the number of packages that is to be produced. In the example described, the packaging tree indicates that the pallet includes 50 boxes, each box including 10 cans. The packaging tree can also include an indication, such as, e.g., indication 322, that shows the number of times a particular labeling type is applied to a packaging layer. For example, the transport label of the pallet is applied three times. The packaging tree can also include an indication, such as, e.g., indication 324, that shows the name of the variant used to generate the label, an indication, such as, e.g., indication 328, that shows the total number of labels of a particular type needed to fulfill the labeling request, and type of label stock that is to be loaded into a printer for printing labels.

One method of simplifying the label determination process is to predefine labeling scenarios. In one implementation, a labeling scenario describes a particular situation in which labels are required. Examples of labeling scenarios can include make-to-stock, make-to-order, labeling-at-shipment, purchased-materials, goods-receipt, development samples, and generic. Instead of supplying all the information usually needed in a request to generate labels, one can simply select a labeling scenario, which selection can provide some or all of the information needed in a request. The labeling scenario itself defines what information is available for a labeling determination.

Labeling scenarios can be predefined and customized by a system administrator. The administrator can create and store any labeling scenario to work with the labeling process. An operator of the system can select one of the predefined scenarios, then all information related to the selected scenario is retrieved from the data structure. Because not every operator needs to access all available scenarios, the system can provide a permission scheme that only makes some scenarios available to particular operators. The administrator can control this authorization object.

The following describes examples of labeling scenarios and the input information required to generate labels for each scenario. One scenario is a make-to-stock scenario. Only data that is available during the production process needs to be entered for label determination at this stage. A process order can be entered, which specifies the material or product and the number of units. If more than one packaged material or product is specified, the operator can enter the desired material or product to be labeled. The system then determines the number of units to be labeled at each layer from the packaging hierarchy and process order. Whether only the specified layer or all the layers below the specified layers will have labels can be input by the operator. Modes of transport and countries are generally not known at the time of production. Plant information can indicate the production plant for the material or the packaging plant. The system determines the plant information from the process order and uses the modes of transport and validity areas that were assigned to the plant for the labeling determination. The validity areas are used to determine the countries belonging to them. The operator can enter other data or overwrite the default entries as needed.

Another scenario that can be used during production is the make-to-order scenario. The information available for this scenario is everything available in the make-to-stock scenario. A production order, which is input into the label determination system, is linked to the corresponding sales order. The sales order can be used to determine the customer, countries, route, and shipping modes needed for labeling. The modes of transport are determined from the route specified in the sales order, while the countries are determined from the originating countries, route by which the packaged materials or products travel, and destination countries.

A labeling-at-shipment scenario can be used for the production of labels during a shipment process. This scenario can also be used for re-labeling packaged materials that have been stored, but need a new label prior to shipping. A delivery note is used with this scenario to determine the necessary data for label determination. One delivery note can have multiple line items and batches. In this case, a pull down menu appears for an operator to select the line item and batch to be used in labeling. The delivery note also specifies the material. An input area for a flag for hierarchy explosion allows the operator to choose whether the present layer or all layers need labels determined. The outermost packaging layer of the hierarchy is set as the default packaging layer for label determination in this scenario. The operator can override this default selection with another layer in the packaging hierarchy.

A goods-receipt labeling scenario can be used to label materials for production or internal material flow. The system determines most of the data required for label determination from a goods receipt material document, which can be entered by the operator. The system gets the material or product, batch number, packaging unit, plant, and number of units from this material document. The operator can specify whether the hierarchy is to be exploded for label determination. The modes of transport and countries are also determined from the plant specified in the goods receipt material document.

The purchased-materials scenario can be used to print labels for incoming purchased materials or products, for internal material flow, or for use in production. The data available can be dependent on the supplier of the packaged materials. Therefore, this scenario has many data items that can be overwritten by the operator. The purchase order number, which contains a list of material numbers and expected quantities, is input to determine the labels. The operator can then overwrite the expected quantity with the actual quantity received and enter a batch number and production date for batch managed materials.

A labeling-developmental-samples scenario is different than the other scenarios in that often there is no valid material data available for the developmental label. This data can be created by using regulatory data for the sample and any operator entered data related to the material. There may be no particular label template associated with the developmental samples. Therefore, the operator manually enter the label size and other label data.

One final example of a predefined scenario is the generic scenario. This scenario allows the operator to enter all data items that are needed for label determination. It can be used for testing reasons or to produce labels that do not fit into any of the previously discussed labeling scenarios.

The foregoing scenarios are examples of scenarios that can be programmed into a label determination system. Other scenarios can be created, programmed, and used in label determination. An administrator can configure the scenarios to meet the operational needs of his business and any regulatory requirements that apply to the materials or business. Any number of data options can be made available for each scenario and the administrator can select what data fields are available for operator enterable data.

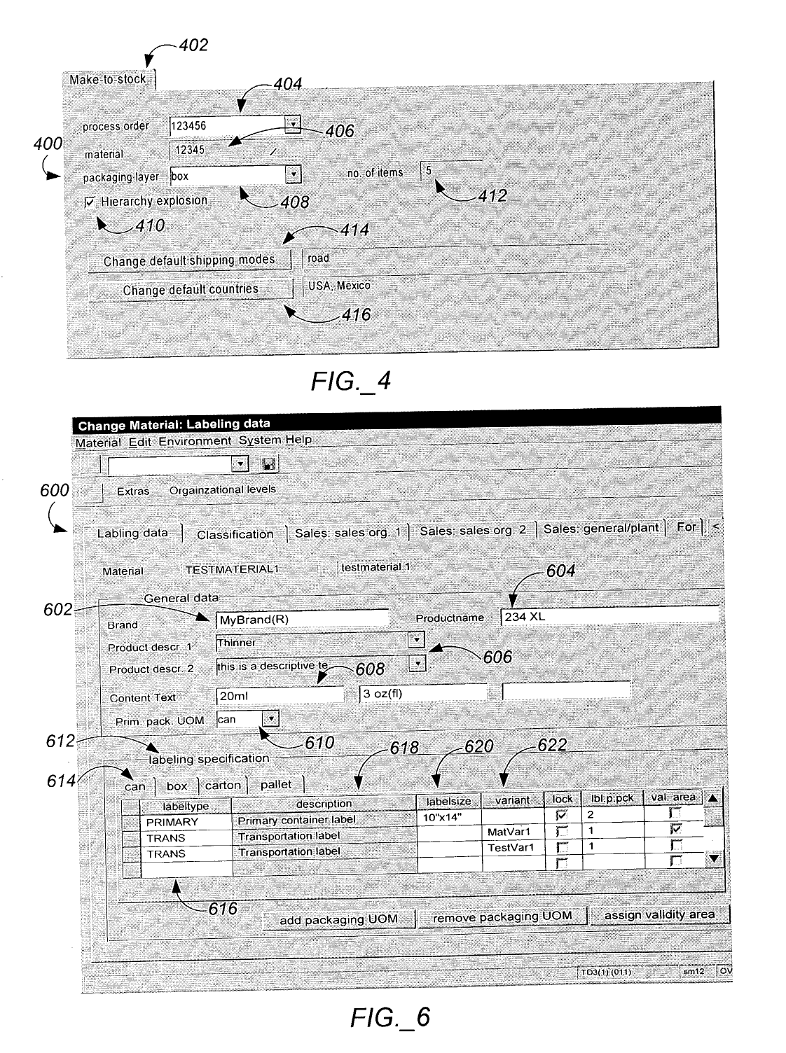

FIG. 4 shows a graphical user interface (“GUI”) 400 that implements the scenario technique described above. An operator can select a scenario by selecting a tab such as, for example, tab 402, which is a tab for a make-to-stock scenario. In this scenario, labels are generated for a material that will be made and stocked. In one implementation, the GUI 400 includes an input field 404 for receiving a process order number. The process order number is a number that is associated with all the materials specified in another input field 406. One process order number can include more than one material for which labels can be printed. If more than one material is available, the operator can, for example, select from a pull-down list of the input field 406. Other pertinent information can be input through the GUI 400 to generate labels. The administrator can configure GUIs for any scenario so that the information in the default scenarios can be overwritten if the operator has information that is different from the default settings in the scenarios.

In the implementation shown, the GUI 400 includes an input field 408 for receiving from an operator a selection or identification of a packaging layer to be labeled. The GUI 400 also includes an input field 410 for receiving input from the operator to indicate whether only the packaging layer specified in input field 408 is to be labeled or packaging layers included in the one specified are also to be labeled. The GUI 400 also includes an input field 412 for receiving from the operator the number of items for the packaging layer specified in input field 408. The GUI includes an input field 414 for specifying a shipping mode or, as shown, for changing the default shipping mode. The GUI 400 can also include an input field 416 for indicating or, as shown, for changing the default countries. The default shipping modes and default countries can, thus, be selected and changed by the operator.

Label data, i.e., the labeling specification, for each material can be maintained in a data structure that can be updated by the operator any time the information changes or materials are added or subtracted from the list of available materials to be labeled. Computer programs that are integrated with the labeling system can also automatically update the fields in the data structure. One specialized type of data structure that can be used with the label determination system is a material master. In one implementation, the material master contains the label types, units, material descriptions, material group designations, and other material related data. The material master can store all of the materials' label data together with material data in a data structure in a way that integrates each material with its associated label data.

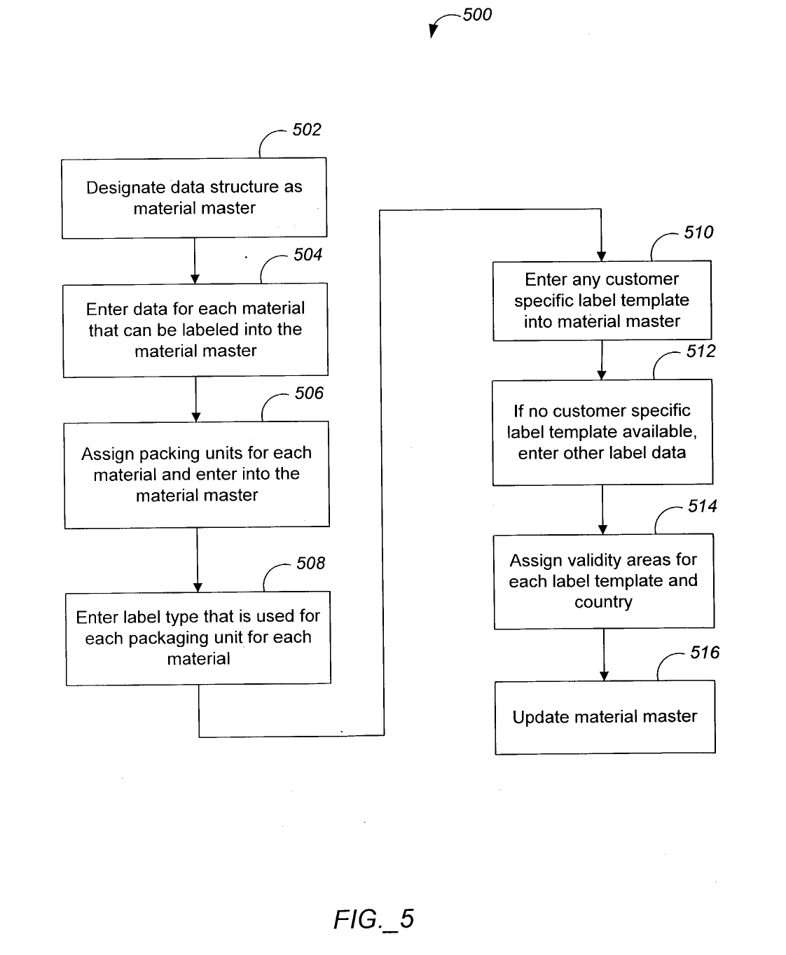

FIG. 5 shows a method 500 for maintaining label data in a material master. The material master is created by starting with a data structure and designating the data structure as the material master (step 502). Data for each material is entered into the data structure (step 504). Generally, the material has a material number designated to identify it. As described above, the material can be packaged in a primary packaging unit, such as, for example, a can, and can be further encased in other packaging units, such as, for example, a six-pack or box. The available packaging units for each material are assigned to each material and entered in the material master (step 506). For some materials, multiple packaging units may be available. For example, a material can be packaged in both bottles and canisters. The bottles can be packaged in cases and the canisters can be packaged in crates. In this situation, both bottles and canisters are entered as the primary packaging unit and the canisters and crates are entered-as the outer packaging units in the material master.

The label type that is used for each packaging unit for each material is entered into the material master (step 508). Therefore, when the material master is queried for a particular material and packaging unit, the result is the label types associated with that material and packaging unit in the material master. At this point, various options may be available for each label type. These options can also be entered in the material master. In one implementation, a customer specific label can be entered into the material master. A label template for customer specific labels can be entered in the material master and associated with the particular customer (step 510). If there is no customer specific label entered into the material master for the label type, other label data can be entered into the material master (step 512). This data can include the label stock, label size, number of symbols that can be printed on the label, plant information, and validity areas. Validity areas are then assigned for each label template and country (step 514). Only certain label templates can be used in certain countries. However, some label templates can be used in multiple countries.

The completed material master can then be integrated with other software programs to enable label determination. Examples of programs that can be used with the material master are product safety programs and dangerous goods management programs. When the material master is integrated with these programs, data can be automatically sent or retrieved from the other programs and used with data in the material master to complete the data needed for a label.

The material master can be updated as the material data changes or additional materials are added or subtracted (step 514). The material master can be maintained by the administrator and updated centrally, or by individual departments, or at different locations of the enterprise. Additional label data entries can be added to the material master and the material master can be configured to automatically update its stored data based on predetermined parameters.

FIG. 6 depicts a GUI 600 for maintaining material data, including labeling specifications, in a material master. In the implementation depicted, the GUI 600 includes an input field 602 for receiving the brand of a material, an input field 604 for receiving the name of the material, an input field 606 for receiving a description of the material, an input field 608 for receiving the content amount of the material in the primary packaging unit, and an input field 610 for receiving a primary packaging unit of the material. The GUI 600 also includes a labeling specification area 612 for input fields for receiving label data. The labeling specification area 612 can display different layers in the packaging hierarchy as a series of tabs such as, for example, tab 614. Each tab is named for the packaging unit found at that layer. The input fields in the labeling specification area 612 includes an input field 616 for receiving the label type name, an input field 618 for receiving text information that describes the labeling type, an input field 620 for receiving label size information, and an input field 622 for associating variants with a label type. Information specific to a packaging unit can be viewed and input by selecting the appropriate tab of the packaging unit of interest. Additionally, other information can be input for determining labeling requirements and can be stored in the material master. For example, the material master can store a phrase library that is used to translate the material description into other languages. Other information, for example, can include a number of units, shipping modes, plant information, countries, transportation symbols, use symbols, bar codes, and validity areas.

Tables of data that are usually not changed during the label determination process can be defined as customizing data structures. A system administrator usually enters customizing data into customizing data structures of a labeling system when the system is first installed. Once entered, customizing data can be retrieved from the data structures as the data is needed by the system. In one implementation, the customizing data structures include label types, label scenarios, label sizes, transport symbol groups, packaging units, default countries and shipping modes, and sequencing numbers, which are described further below.

Data structures that must be maintained, or which contain objects that must be added or removed during the label determination process, can be defined as master data structures. A dialog screen is made available to the operator to make the necessary selections from a list of options offered by the system. Alternatively, the operator can enter data at this dialog screen. In one implementation, four data structures are maintained as master data structures. The master data structures include the labeling specification, label stock—the paper the label data is printed on, customer specific labels, and operator enterable data. Additional data structures can be added for label content determination and can include material specific, customer specific, material and customer specific, and plant specific label content. Further, label content fetched from another table, such as a dangerous goods table, can be used for label content determination. The master data structures can contain all of the above described data structures.

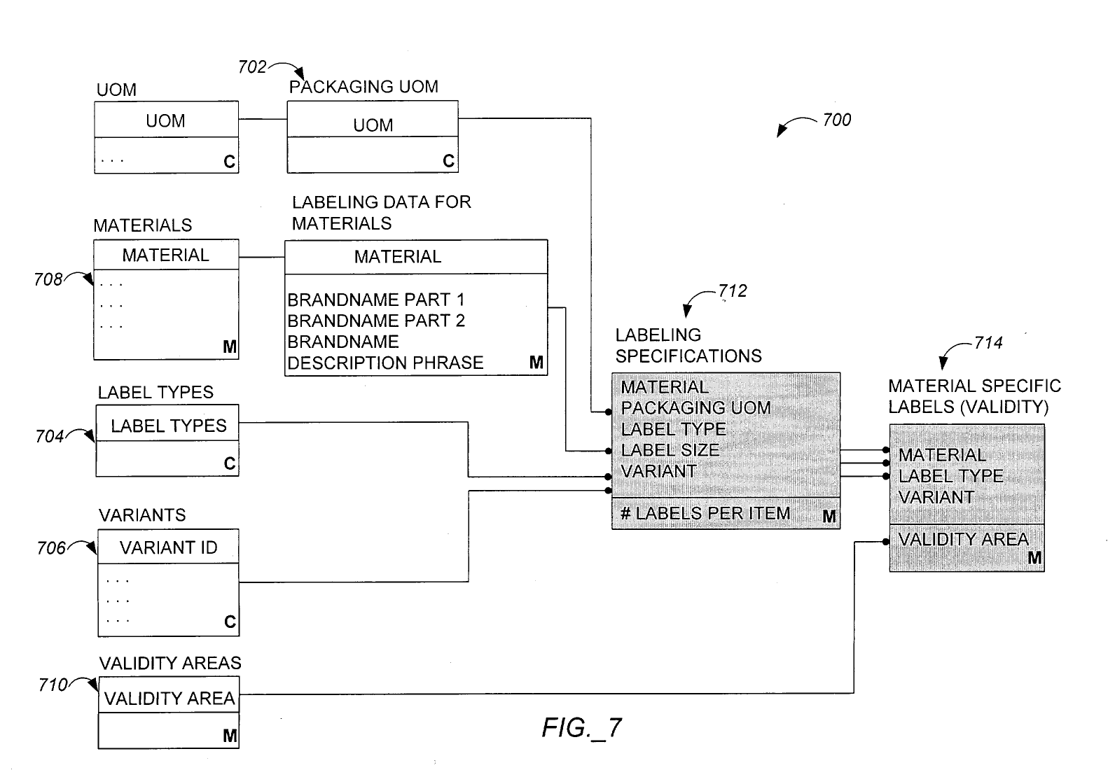

FIG. 7 shows examples of components of a labeling specification 700. The packaging unit 702, label types 704, and variants 706, for example, are defined as customizing data. The materials 708, validity areas 710, labeling specifications 712, and material specific labels 714, for example, are defined as master data. The validity areas 710 designate the geographical regions where a label can be used. One reason for using different labels in different geographical regions is compliance with regulatory standards. In some countries, transportation regulations require particular packaged material to be labeled as hazardous. The required labels can be of a specified size, color, or font type. The label data can include these attributes and match labels with qualifying attributes for a particular geographic region. Another reason for different validity areas can be for market preference purposes. If a particular type of labeling is preferred in Japan, but not Brazil, an operator can select different labels for each country based on local consumer preference.

The validity area 710 in the labeling specification 712 indicates which label type is valid in a particular country. If no validity area 710 is entered, the label determined is valid in all geographic areas. If a validity area 710 is entered, then the operator can define a material specific private label. This private label indicates that the material is only allowed in the regions that are the designed validity areas 710. Along the same lines as defining validity areas 710, the administrator or user can lock out the use of a particular label for a certain material 708, packaging unit 702 and label type 704 so that the label can not be produced.

In one implementation, an operator can enter data to be included on the label as data items. In this implementation, two different types of operator enterable data exist. The first type of operator enterable data is tied to the labeling scenario and allows the operator to enter valid values for all labels printed in one labeling case. For example, a batch number or production date may apply to the entire scenario. The data items are entered only one time and are printed on every label in the scenario. The other type of operator enterable data is tied to the label template and allows the operator to enter values that apply to one specific label. For example, the operator may enter a customer order number or other customer specific information. This information is only printed on a specific label and is only displayed if this label is to be printed. Alternatively or additionally, there can be an indication, such as a flag that can be added for printing different data on all labels printed for the same packaging layer. In this case, the system generates an input-screen that allows the operator to enter different values for each label prior to printing. This feature may be implemented when applying a serial number to a product. Another method of assigning unique data to labels is by using a SAP R/3 application that is called before the entry areas for data items are displayed.

In one implementation, data items tied to a particular label template is a sequence of numbers. When sequenced numbers are applied to each label, the sequencing number is stored in the system and is used every time labels that match a given criteria are printed. One example of a sequence number being applied to labels is a customer specific sequencing number, which produces a new sequence number for every item that is sent to a particular customer. For each customer, a separate thread of sequencing numbers can be created. Another example of a sequencing number is applying a unique sequencing number to every label of a certain material. A new thread of sequencing numbers is created for every material. A third example of a sequencing number is a material and customer specific sequencing number that creates a unique number for each label that is printed for a specific material and customer combination. This means a different sequencing number is applied to the same material when sent to different customers and different sequencing numbers are applied to different materials that are sent to the same customer. Material and batch specific sequencing numbers also can be created for each batch of a material. One final example of a sequencing number is a plant specific sequencing number, which is a number uniquely created for each production plant. An administrator can program any other sequencing number to be applied to a label template into the label determination system.

The label determination system can define several sequencing numbers for specific labeling situations. If the sequencing number is stored, a sequencing number storage table can be created to store a record of every thread of a stored sequence number. The system can also define which criteria are used to decide when a new thread of sequence number must be created.

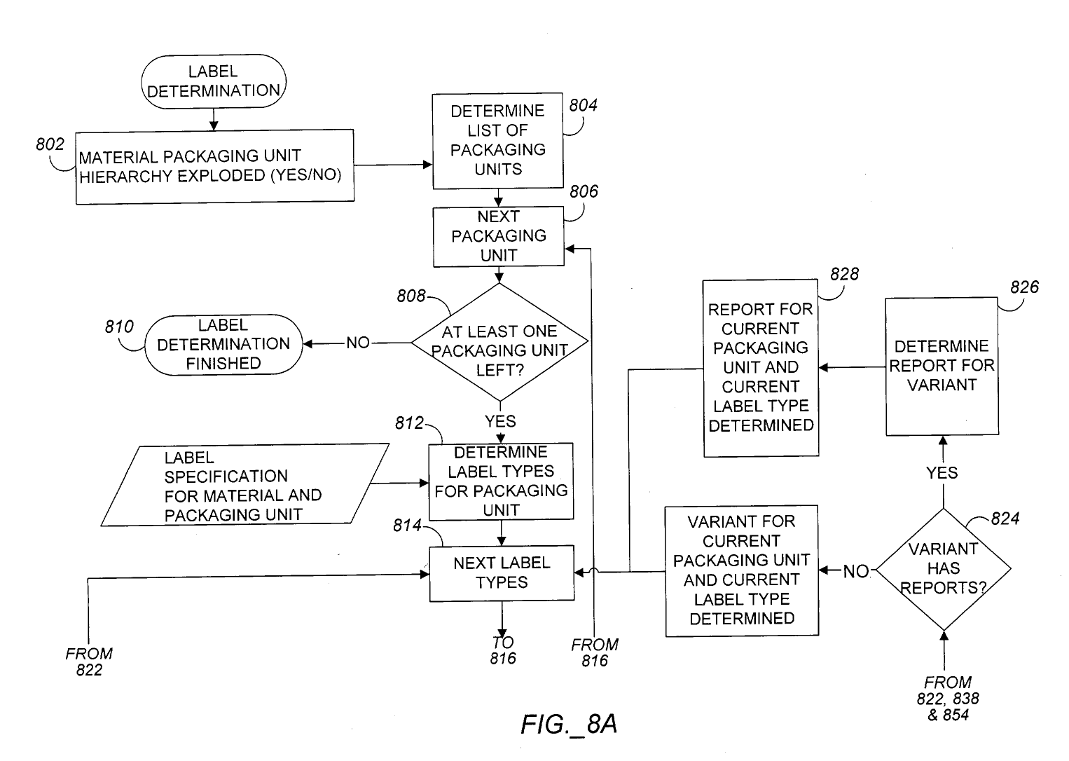

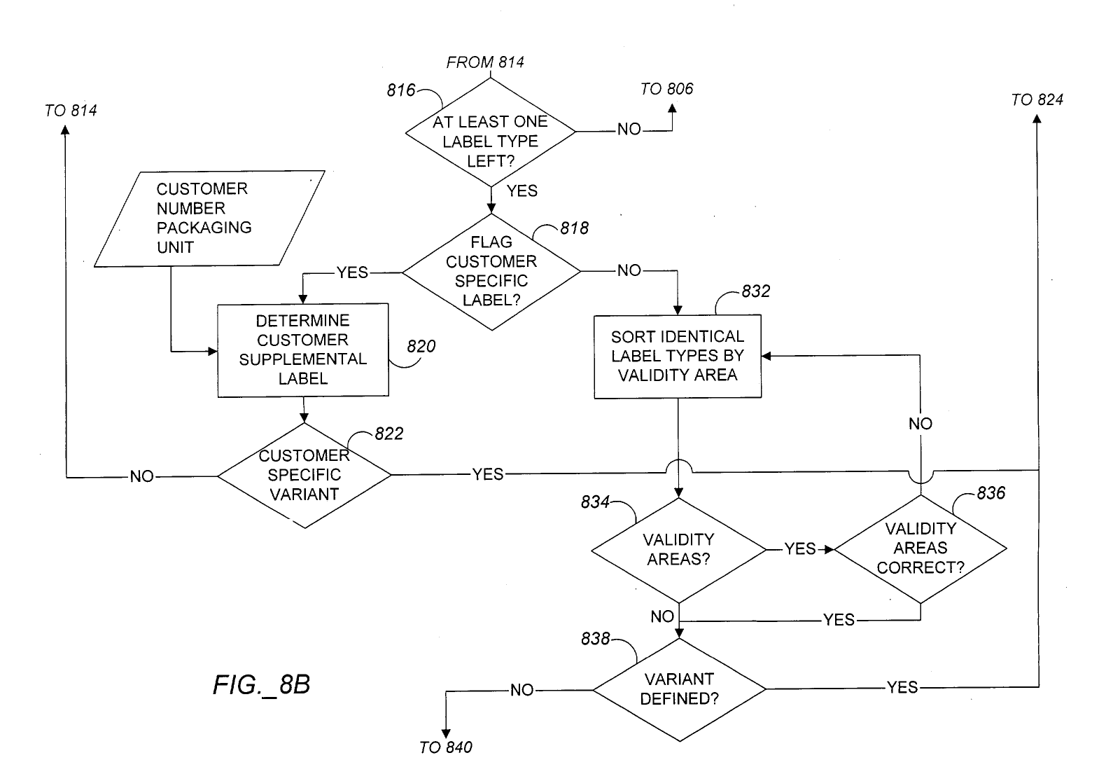

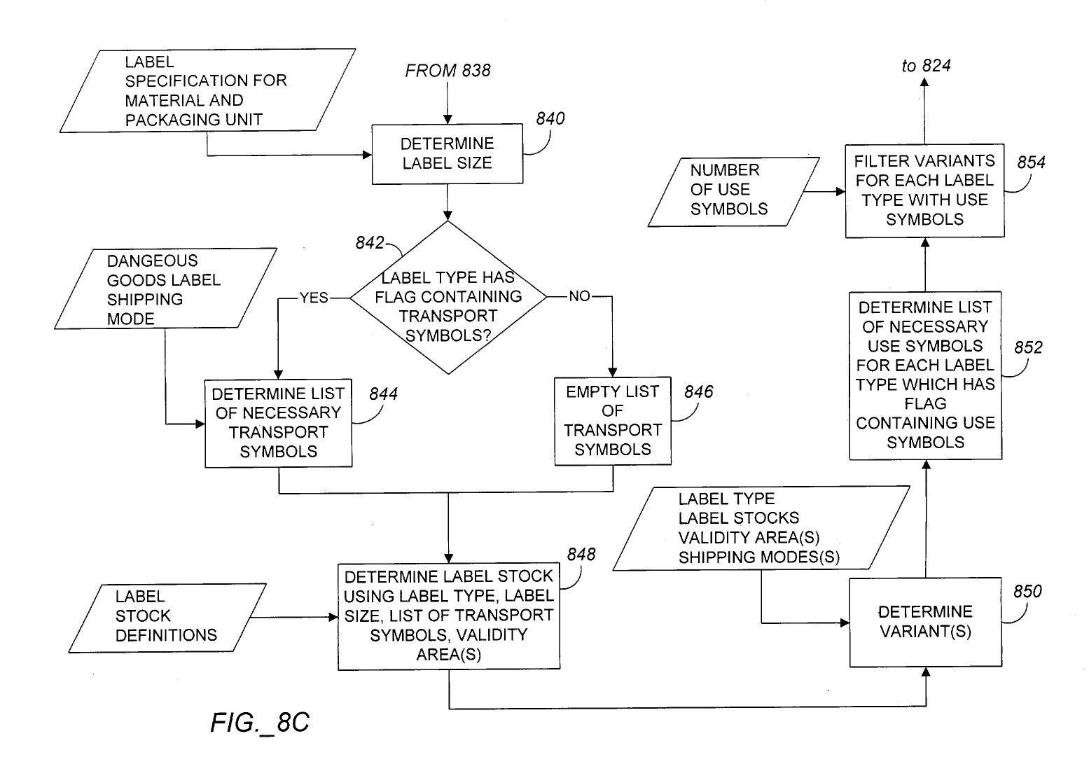

FIG. 8 shows a detailed method 800 for determining labeling requirements. The system finds the list of packaging units that can be used for the label determination once the material, packaging unit, and hierarchy explosion is input (step 802). The system determines the list of packaging units to be labeled (step 804). The system selects a next unselected packaging unit to be labeled (806). The system determines whether there are at least one packaging units remaining that are unselected (step 808). If there are not at least one packaging units remaining, the label determination is finished (step 810). If there are packaging units remaining, the system determines all the label types for the packaging unit from the labeling specification, which is associated with the material and packaging unit input (step 812). Then, for each packaging unit, the system selects the next label type that can be applied to the current packaging unit (step 814). If there is at least one label type to be determined (step 816), the system returns to step 804 and selects the next packaging unit to be labeled, otherwise the system proceeds to step 818.

The system checks for a flag indicating a customer specific label (step 818). If a customer specific flag associated with the label type is found, the system determines the customer supplemental label using the customer number and packaging unit (step 820). The system then searches for a customer specific variant (step 822). If no customer specific variant is found, the system returns to step 814 to continue with the next label type. If a customer specific variant is found, the system searches for a variant report (step 824). If a report exists, the system determines the report (step 826). The system then uses the report for the current packaging unit and label type (step 828). If no report is found, the system determines the variant for the current packaging unit and current label type (step 830). Once the system determines the report or variant, the system uses the report or variant in the labeling tree, the system returns to step 814.

If the system does not find a customer specific label, then the system sorts identical label types by validity area (step 832). The system checks for validity areas (step 834). If there are validity areas, the systems checks whether they are correct (step 836). If the validity areas are not correct, the system returns to step 832. If the validity areas are correct, or if there are no validity areas, the system determines whether a variant is defined in the labeling specification (step 838). For example, one of the variants that can be defined is a material specific variant. If the system finds a variant defined in the labeling specification, the system continues onto step 824.

If no variant is defined in the labeling specification, the system determines the label size based on the labeling specification for the material and packaging unit (step 840). The system checks the label type for transport symbols (step 842). If the current label is flagged for a transport symbol, the system determines the list of transport symbols that have to be printed on the label from the dangerous goods label and shipping mode (step 844). If there are no flags for transport symbols, no transport symbols are added to the label (step 844).

The system continues with determining the label stock using the label type, label size, list of transport symbols and validity areas, and by selecting from the label stocks defined and stored in the system (step 848). Variants are then determined from the label type, label stocks, validity areas, and shipping modes (step 850). The system then determines the list of necessary use symbols for each label type which has a flag indicating that the label type contains use symbols by using the material and validity area information (step 852). The system then filters variants for each label type, using the number of use symbols input into the system (step 854). The system then continues to step 824.

If an operator uses the above method, the operator selects the labeling scenario and enters the data known about the material. The operator also must select a printer and starts the label determination program. The system can ask the operator for scenario level operator enterable data, which the operator then enters if any such data exists. The operator can select a label from the displayed tree to enter the template level operator enterable data and enter a start value for any sequencing number that will be applied to the labels. The final step is printing the labels.

If an operator does not enter a request for labels or information into the system, a software program can call the label determination system to enter the material and packaging unit. An example of a software program requesting a label determination is a supply chain management program of SAP's label determination suite. The labeling determination is started when necessary information is entered from the calling programs. When labeling determination has been completed, the calling program can return to its own software function.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and the computer program can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention can be implemented in a computing system that includes a back-end component, e.g., as a data server, or that includes a middleware component, e.g., an application server, or that includes a front-end component, e.g., a client computer having a graphical user interface or a Web browser through which an operator can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results. In alternative implementations, the system can cause the described hierarchy explosion to include layers in the packaging hierarchy other than those described. That is, layers above the packaging layer selected can also be included in the hierarchy explosion. In a situation where there is too much data to be printed on a label due to label size constrains, the system can alert the operator and allow the operator an opportunity to remedy the problem. The operator can reduce the validity areas so that the label contains less data, select a different label size, print multiple labels with the information divided onto each label, or select another option that rectifies the problem.

What is claimed is:

1. A computer-implemented method for determining label requirements, the method comprising:
receiving a request that includes information describing one of one or more products, one or more materials, and packaging;
identifying, based on the request, one or more packaging layers that are to be labeled;
selecting, for each packaging layer identified, one or more label templates;
determining data that is needed to complete the label templates selected;
retrieving the data from memory; and
generating a representation of the packaging label using the one or more label templates and the data.

2. The method of claim 1, wherein:
selecting a label template includes selecting a variant of the label template when there are one or more variants associated with the label template; and
generating a representation of the packaging labels includes using the variant selected to generate the representation.

3. The method of claim 2, wherein:
receiving a request includes receiving a request that specifies a customer; and
selecting a variant includes determining whether there are one or more variants associated with any one of the customer, the product, the material, and the packaging layer.

4. The method of claim 1, further comprising:
generating a labeling tree that describes the packaging labels needed to fulfill the request.

5. The method of claim 1, further comprising:
generating a label hierarchy; and
calculating a number of labels needed, the calculation being based on the label hierarchy.

6. The method of claim 1, wherein:
receiving a request includes receiving a selection of a predefined labeling scenario, the predefined labeling scenario specifying at least some of the information that describes the one or more products, the one or more materials, the packaging, and the operation; and
selecting the label templates is based on the predefined labeling scenario.

7. The method of claim 6, wherein:
receiving a predefined labeling scenario includes receiving one of a make-to-stock scenario, a make-to-order scenario, a labeling-at-shipment scenario, a purchased-materials scenario, a goods-receipt scenario, a development-samples scenario, and a generic scenario.

8. The method of claim 1, wherein:
receiving a request includes receiving information that describes an operation; and
selecting the label templates includes selecting the label templates based on the information that describes the operation.

9. The method of claim 8, wherein receiving a request includes receiving information that specifies one or more validity areas, the method further comprising:
determining, based on the one or more validity areas, which of the label templates are to be selected, wherein selecting the label templates includes selecting the label templates based on the one or more validity areas.

10. The method of claim 9, wherein:
receiving a request includes receiving information that specify one or more modes of transportation; and
selecting the label templates includes determining, based on the one or more validity areas and the one or more modes of transportation, whether transportation symbols are required.

11. The method of claim 1, wherein:
retrieving the data includes retrieving the data from a material master.

12. The method of claim 1, further comprising:
requesting operator input to supplement the received information;
accepting the operator input; and
utilizing the operator input to generate the representation.

13. The method of claim 1, wherein:
identifying packaging layers includes identifying packaging layers that are included in the packaging layer specified in the request.

14. A computer program product, tangibly embodied in an information carrier, for determining labeling requirements, the product being operable to cause a data processing apparatus to:
receive a request that includes information describing one of one or more products and materials, the information also describing packaging;
identify, based on the request, one or more packaging layers that are to be labeled;
select, for each packaging layer identified, one or more label templates;
determine data that is needed to complete the label templates selected;
retrieve the data from memory; and
generate a representation of the packaging label using the one or more label templates and the data.

15. The product of claim 14, being further operable to cause a data processing apparatus to:
receive information describing an operation; and
select the label temples based on the information that describes the operation.

16. The product of claim 14, being further operable to cause a data processing apparatus to:
select a variant of the label template when there are one or more variants associated with the label template and use the variant to generate the representation.

17. The product of claim 16, being further operable to cause a data processing apparatus to:
receive a request that specifies a customer; and
determine whether there are one or more variants associated with any one of the customer, the product, the material, and the packaging layer.

18. The product of claim 14, being further operable to cause a data processing apparatus to:
generate a labeling tree that describes the packaging labels needed to fulfill the request.

19. The product of claim 14, being further operable to cause a data processing apparatus to:
generate a label hierarchy; and
calculate a number of labels needed, the calculation being based on the label hierarchy.

20. The product of claim 14, being further operable to cause a data processing apparatus to:
receive a selection of a predefined labeling scenario, the predefined labeling scenario specifying at least some of the information that describes the one or more products, the one or more materials, the packaging, and the operation; and
select the label templates based on the predefined labeling scenario.

21. The product of claim 20, being further operable to cause a data processing apparatus to:
receive one of a make-to-stock scenario, a make-to-order scenario, a labeling-at-shipment scenario, a purchased-materials scenario, a goods-receipt scenario, a development-samples scenario, and a generic scenario.

22. The product of claim 21, being further operable to cause a data processing apparatus to:
determine, based on the one or more validity areas, which of the label templates are to be selected; and
select the labeling templates based on the one or more validity areas.

23. The product of claim 20, being further operable to cause a data processing apparatus to:
receive a request wherein the operation information specifies one or more modes of transportation; and
determine, based on the one or more validity areas and the one or more modes of transportation, whether transportation symbols are required.

24. The product of claim 14, being further operable to cause a data processing apparatus to:
retrieve the data set from a material master.

25. The product of claim 14, being further operable to cause a data processing apparatus to:
request operator input to supplement the received information;
accept the operator input; and
utilize the operator input to generate the representation.

26. The product of claim 14, being further operable to cause a data processing apparatus to:
identify as needing to be labeled a packaging layer that is included in the packaging layer that is specified in the request.
